(19) United States
(12) Patent Application Publication
(10) Pub. No.: US 2003/0172143 A1
(43) Pub. Date: Sep. 11, 2003

(54) Access node apparatus and method for internet using condition analysis

(76) Inventor: Koji Wakayama, Kokubunji (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/214,566

(22) Filed: Aug. 9, 2002

(30) Foreign Application Priority Data
Mar. 6, 2002 (JP) P2002-060217

(51) Int. Cl. G06F 15/173

(52) U.S. Cl. 709/223; 709/229

(57) ABSTRACT

An access node apparatus capable of analyzing the Internet using condition of each user terminal according to the user profile information is proposed. In a process of a series of control procedures executed between a user terminal and an authentication server, the access node apparatus generates a management record that denotes the correspondence between the user ID and the IP address, then generates a data record that denotes a relationship between a packet receiving time and the destination/source IP address. The access node apparatus then stores the access record that includes the user ID generated from both of the data record and the management record in a table and uses the user profile table to execute a statistical processing according to the user profile.

### BACKGROUND OF THE INVENTION

(1) Field of the Invention

The present invention relates to a packet communication system and a network using condition analyzing method. More particularly, the present invention relates to an access node apparatus disposed between an access network connected to a plurality of user terminals and an Internet service provider (ISP), as well as an Internet using condition analyzing method.

(2) Description of the Related Art

Conventionally, many Internet service providers (hereinafter, to be referred as the ISP, respectively) have adopted a connection time based accounting system for the connection between each user terminal and the Internet as an accounting method applied for Internet users. In recent years, however, they come to employ a fixed connection system that charges a fixed amount of monthly fee regardless of the Internet connection time. In addition, access networks used to connect user terminals to ISP networks are coming to employ such broadband Internet access methods as the Asymmetric Digital Subscriber Line (ADSL) and the Fiber To The Home (FTTH) instead of the conventional dial-up access method that uses analog telephone lines and the Integrated Services of Digital Network (ISDN) now that the service information delivered through the.Internet is diversified.

Competition of enclosing users among ISPs is getting heated up more and more year by year, so that each ISP is now driven by necessity to reduce the fee of its broadband Internet connection line. Consequently, each ISP is urged to increase the subscribers and secure new income sources instead of such the Internet connection fee by providing the users with new additional services distinguished from other ISPs so as to recover the cost of providing its network services.

A delivery service of contents by each ISP itself is one of such the new additional services. The ISP can expect accounting for delivered contents and an increase of subscribers of such useful contents as movies, etc. provided by the ISP. In addition, the ISP can also expect advertising revenues from corporations for the advertisement delivered with those contents.

An ISP, when providing the users with a new additional service as described above, is duly required to make a survey of how the users use the Internet. The result of the survey will thus become very useful for other Internet Web service information providers. And, the survey result will also become a new income source of such the ISP if the survey is done accurately.

There is a well-known method for making such a survey of accesses by Internet users. According to the method, a dedicated survey software program is installed beforehand in each user terminal, so that the accessed address is stored each time the user accesses the Internet and a survey server collects the data from the user terminal. There is also another method that each WWW (World Wide Web) server is provided with a counter and the accesses to the server are counted by the counter.

The official gazette of JP-A No.2001-44992 discloses a network node (monitoring node) that, when authenticating a user, obtains the user's identifier from the authentication server (ex., RADIUS server) and stores the data denoting a relationship between this user identifier and the network address (an IP address assigned to the user). And, the network node, when receiving a data packet from a user, compares the network address of the received packet with the above-described data, thereby deciding the source user of the received packet practically in real time.

The method that installs a dedicated software program in each user terminal, however, just collects the data of each connected user terminal when the subject WWW server is specified though a browser running on the user terminal. The method cannot collect any packet data sent to the user terminal from the WWW server. Consequently, the method cannot know a precise time band in which, for example, such streaming data as movies is actually delivered to the user terminal from a server. On the other hand, the method that prepares a counter in each WWW server cannot recognize any user profile nor distinguish accesses that are done between different servers.

According to the method disclosed in the official gazette of JP-A No.2001-44992, because the source user identifier of each packet received from a user terminal can be identified even when the IP address is assigned dynamically to the user terminal, it is possible to generate the network using condition data of the user, which denotes each server accessed by the user if the user terminal IP is corresponded to the destination address of the received packet. However, the monitoring node disclosed in the above official gazette is not intended to analyze users who access various types of servers connected to the Internet. In other words, the above-described conventional technique just enables each user's network using condition data to denote the number of received packets, the number of bytes, the number of packet flows, and the network addresses (destination and source IP addresses and port numbers) corresponding to each user identifier and each requested service, thereby performing user level accounting, as well as providing the users with prepaid services and assuring the users of the service quality (QoS) according to the above using condition data.

### SUMMARY OF THE INVENTION

Under such circumstances, it is an object of the present invention to provide a network access node apparatus that can analyze each user access to each destination via the terminal accurately and how the user uses the Internet.

It is another object of the present invention to provide a network access node apparatus that can analyze how each user uses each destination via the terminal, including the packet transfer from the Internet to the user terminal and a method for analyzing how each user uses the Internet.

It is still another object of the present invention to provide a network access node apparatus that can analyze how each user uses the Internet according to the user profile information and a method for collecting data about how each user uses the Internet.

According to one aspect of the present invention, in order to achieve the above objects, the access node apparatus of the present invention, which is to be disposed between an access network connected to a plurality of user terminals and a network service provider (ISP) network connected to the Internet and enabled to connect any of the user terminals to a user authentication server so as to authenticate the user, comprises:

a user profile table for storing the profile information of each ISP network user corresponding to the identifier;

means for generating a management record denoting the correspondence between a user identifier and an IP address assigned to each of the user terminals in a process for executing a series of control procedures between the user terminal and the access node apparatus and between the user terminal and the authentication server prior to the connection of the user terminal to the ISP network;

means for generating a data,record when receiving a packet sent from the user terminal to the server connected to the Internet, the data record denoting a relationship among a packet receiving time, a source IP address, and a destination IP address of the received packet;

means for generating a server access record denoting a relationship among the source IP address, the receiving time, and the user identifier of the received packet according to the data record and contents of the management record, then storing the generated server access record in an access data table; and

means for generating statistical data analyzed in correspondence with user profile information for each server denoted by the source IP address with use of data stored in both of the access data table and the user profile table.

According to another aspect of the present invention, the access node apparatus of the present invention, which comprises means for generating a data record when receiving a packet sent to the user terminal from a server connected to the Internet, the data record denoting a relationship among a packet receiving time, a source IP address, and a destination IP address of the received packet and means for generating a server access record denoting a relationship among the source IP address, the receiving time, and the user identifier of the received packet according to the data record and contents of the management record, then storing the generated server access record in an access data table, is intended to generate statistical data analyzed in correspondence with user profile information for each server denoted by the source IP address with use of the data stored in both of the access data table and the user profile table.

According to the first embodiment of the present invention, the access node apparatus comprises a plurality of input/output line interfaces connected to the access network or ISP network, a switch for switching packets between the input/output line interfaces, and a control processor connected to the plurality of input/output line interfaces. And, one of the plurality of input/output line interfaces includes the data record generating means and the control processor is provided with the user profile table and enabled to function as the management record generating means, the server access record generating means, and the statistical data generating means, respectively.

However, the access node apparatus can also include an external terminal connected to the control processor and enabled to function as the statistical data generating means.

Furthermore, according to the first embodiment of the present invention, one of the plurality of input/output line interfaces is provided with a memory for storing the data record and the control processor collects data records from the plurality of input/output line interfaces at a predetermined timing to convert each of those data records to an access record used for accessing the server.

The Internet using condition analyzing method of the present invention, which is to be employed for an access node apparatus disposed between an access network connected to a plurality of user terminals and a network service provider (ISP) network connected to the Internet and enabled to connect any of the user terminals to a user authentication server so as to authenticate the user prior to the connection of the user terminal to the ISP network, comprises the steps of:

generating a management record denoting the correspondence between a user identifier and an IP address assigned to each of the user terminals in a process for executing a series of control procedures between the user terminal and the access node apparatus and between the user terminal and the authentication server prior to the connection of the user terminal to the ISP network;

generating a data record when receiving a packet sent from the user terminal to the server connected to the Internet, the data record denoting a relationship among a packet receiving time, a source IP address, and a destination IP address of the received packet;

generating a server access record denoting a relationship among the source IP address, the receiving time, and the user identifier of the received packet according to the contents of a user profile table that stores the profile information of each ISP network user corresponding to the prepared identifier and the contents of the data record, then storing the generated server access record in an access data table; and

generating statistical data analyzed in correspondence with the user profile information for each server denoted by the destination IP address with use of the data stored in both of the access data table and the user profile table.

These and other objects, features, and functions of the present invention will become more apparent as the description proceeds with the detailed preferred embodiment with reference to the accompanying drawings in which:

### BRIEF DESCRIPTION OF THE DRAWINGS

FIG. 1 is a block diagram of a network that employs an access node apparatus of the present invention;

FIG. 2 is a block diagram of an access node apparatus 10-1 of the present invention;

FIG. 3 is a block diagram of an input/output line interface 11-1 of the access node apparatus 10-1;

FIG. 4 is a format of the packets sent/received between a user terminal and the access node apparatus 10-1;

FIG. 5 is a format of the packets transferred inside the access node apparatus 10-1;

FIG. 6 is an access information record generated by the input/output line interface 11-1;

FIG. 7 is an embodiment of a control processor 30 of the access node apparatus 10-1;

FIG. 8 is contents in a user profile information table 33 provided in the control processor 30;

FIG. 9 is contents in a session management table 34 provided in the control processor 30;

FIG. 10 is a chart for describing a sequence for establishing a PPP session between a user terminal and the access node apparatus 10-1;

FIG. 11 is a format of control packets sent in an authentication phase shown in FIG. 10;

FIG. 12 is contents in a collected data memory 35 provided in the control processor 30;

FIG. 13 is contents in an access data table 360 formed in a user access information memory 36 provided in the control processor 30;

FIG. 14 is an embodiment of a statistical data table generated by the control processor 30;

FIG. 15 is a flowchart for an embodiment of a statistical processing routine executed by the control processor 30;

FIG. 16 is another embodiment of the statistical data table generated by the control processor 30; and

FIG. 17 is a flowchart for another embodiment of the statistical processing routine executed by the control processor 30.

### DETAILED DESCRIPTION OF THE PREFERRED EMBODIMENTS

Hereunder, a preferred embodiment of the present invention will be described with reference to the accompanying drawings.

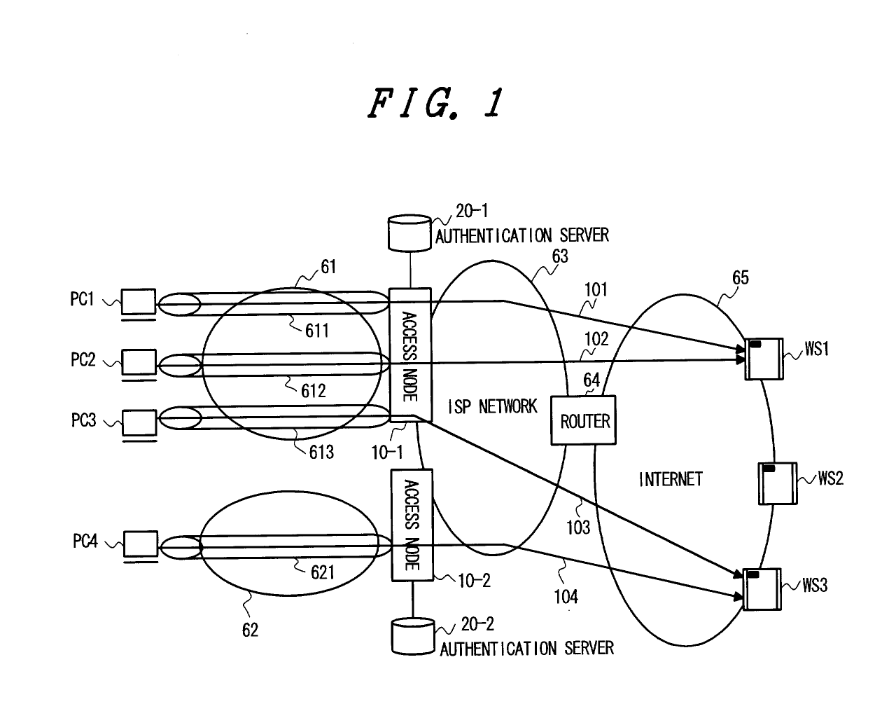

FIG. 1 shows a block diagram of a network that employs the access node apparatus of the present invention.

User terminals PC1 to PC3 are connected to an access node apparatus 10-1 via an access network 61. A user terminal PC4 is also connected to the access node apparatus 10-1 via another access network 62. The access node apparatuses 10-1 and 10-2 are connected to the Internet 65 connected to various types of servers WS1 to WS3 via an ISP network 63 and a router 64. The access node apparatus 10-1 is connected to such an authentication server 20-1 as, for example, a RADIUS server and the access node apparatus 10-2 is connected to another authentication server 20-2.

Each of the user terminals PC1 to PC3 is required to set a Point to Point Protocol (PPP) session (661 to 663) between itself and the access node apparatus 10-1 prior to the connection to the Internet 65 so as to communicate with the authentication server 20-1 and authenticate its user via the access node apparatus 10-1. Similarly, the user terminal PC4 is required to set a PPP session 621 between itself and the access node apparatus 10-2 to communicate with the authentication server 20-2 and authenticate its user.

When the above user authentication is successful, the access node apparatus assigns an IP address to the user terminal. The user terminal uses the assigned IP address as a source IP address to access a desired server. In FIG. 1, after the user authentication processing, the user terminals PC1 and PC2 communicate with the server WS1 as denoted by the arrows 101 and 102, respectively and the user terminals PC3 and PC4 communicate with the server WS3 as denoted by the arrows 103 and 104, respectively.

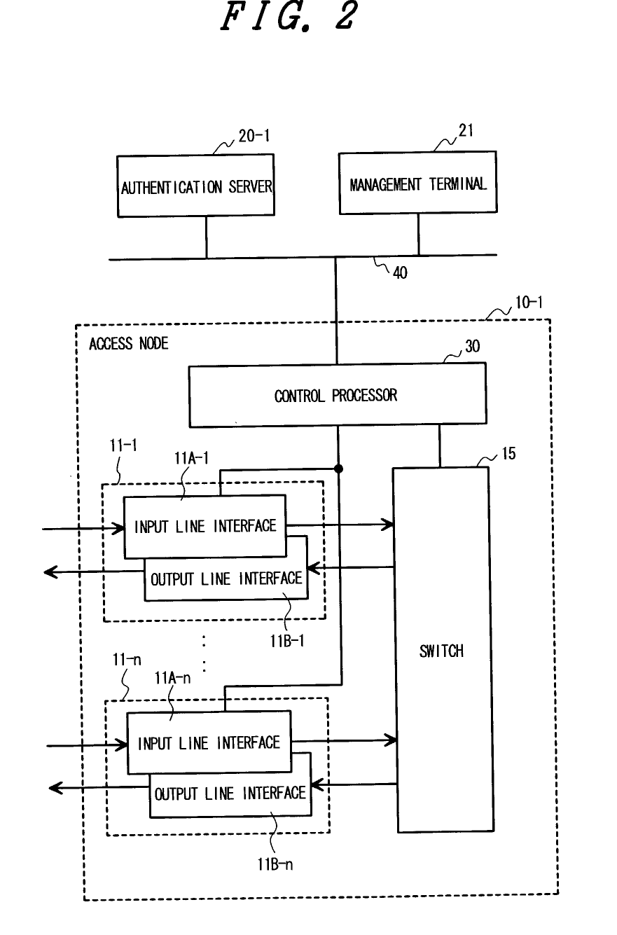

FIG. 2 shows a block diagram of the access node apparatus 10-1. The block diagram of the access node 10-2 is also similar.

The access node apparatus 10-1 is configured by a plurality of input/output line interfaces 11-i (i=1 to n) used to connect itself to an access network 61 or ISP network 63, a switch 15 used to switch packets among the plurality of input/output line interfaces, and a control processor 30 connected to each of those input/output line interfaces 11-i. The input/output line interfaces 11-i are divided into input line interfaces 11A-i and output line interfaces 11B-i.

The control processor 30 is connected to an external authentication server 20-1 and a control terminal 21 via a LAN 40. This control terminal 21 is used by its operator to input commands to assign various parameters and an Internet Protocol (IP) address required for each input/output line interface.

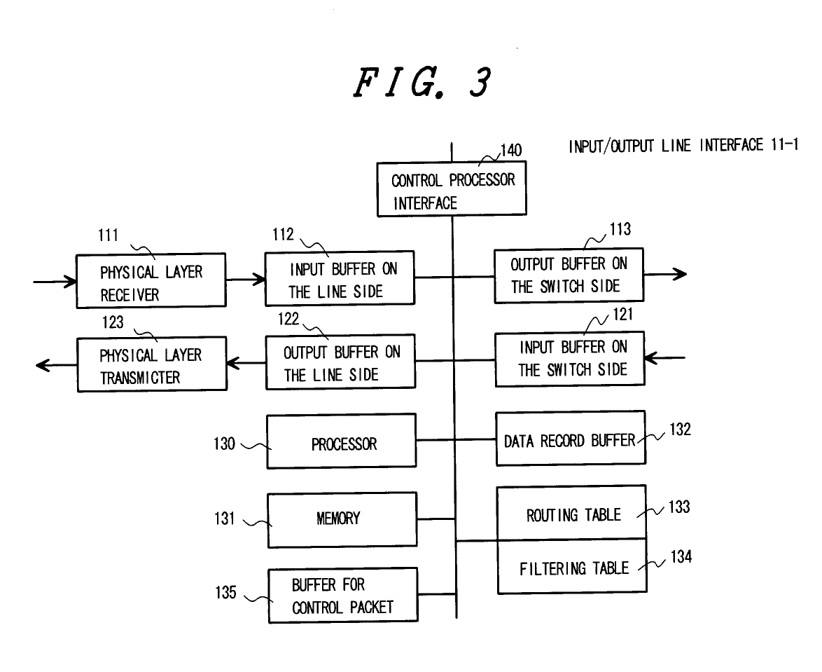

FIG. 3 shows an embodiment of the input/output line interface 11-1.

The input/output line interface 11-1, as shown in FIG. 3, can be divided into an input line interface 11A-1 and an output line interface 11B-1. In this embodiment, however, both of the input line interface and the output line interface are configured so as to share a packet transfer control processor 130.

Each packet received from a network input line is subjected to an OSI standard model physical layer processing in a physical layer receiver 111, then stored in an input buffer on the line side 112. The received packet stored in the buffer 112 is read by the processor 130 and subjected to header conversion and internal header addition, then inputted to the switch 15 via an output buffer on the switch side 113.

When the received packet is a control packet to be sent to the control processor 30 or authentication server 20-1, the processor 130 sends the received packet to the LAN 40 via the control processor interface 140. On the contrary, a control packet, when it is received via the control processor interface 140 and addressed to a user terminal from the control processor 30 or authentication server 20-1, is stored temporarily in a control packet input buffer 135, then transferred to an output buffer on the line side 122 by the processor 130.

On the other hand, each transmit packet output from the switch 15 is stored in the input buffer on the switch side 121. The transmit packet stored in the buffer 121 is then read by the processor 130 and the unnecessary internal header is removed from the packet, which is then subjected to header conversion as needed. After this, the transmit packet is inputted to the output buffer on the line side 122 and output to the network output line via the physical layer transmitter 123.

The processor 130 transfers a received packet and a transmit packet alternately under the control of a control program stored in the memory 131. The processor 130 refers to the routing table 133 and the filtering table 134 to convert header information and generate the internal header of each packet. The processor 130 also discards each received packet having specific header information and generates a data record for each received packet according to the control information read from the filtering table 134. The generated data record includes user access information, which is featured by the present invention.

The generated data record is stored in the data record buffer 132, then sent to the control processor 30 at a proper timing via the control processor interface 140. The data in the routing table 133 and in the filtering table 134 are set by the control processor 130 via the control processor interface 140 in response to a command input from the control terminal 21.

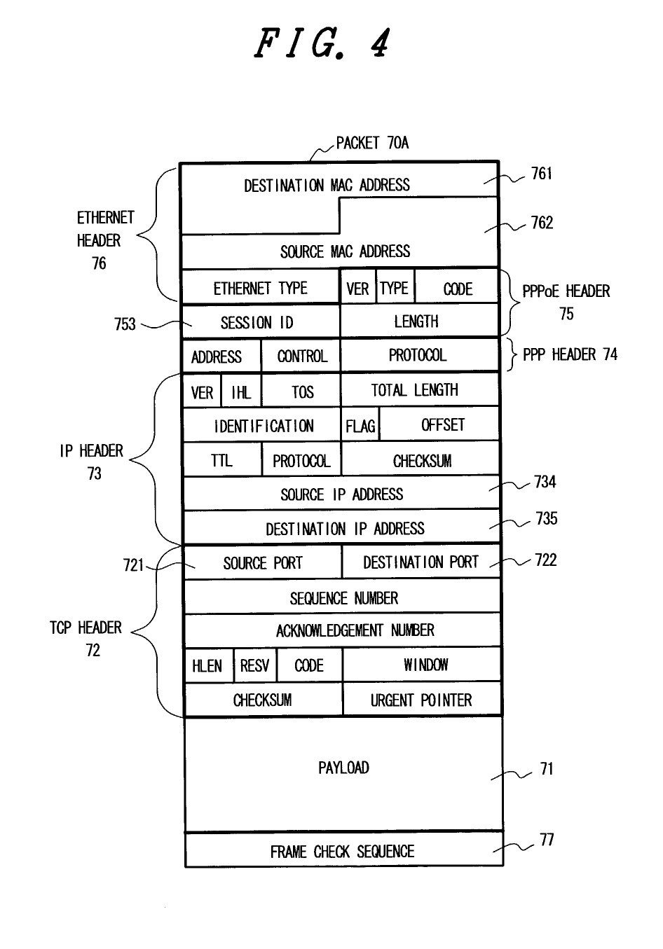

FIG. 4 shows a format of a packet 70A to be sent/received between a user terminal and the access node apparatus 10-1/10-2 while the PPP over Ethernet (PPPoE) is employed for the access network 61. The packet 70A is configured by a payload part 71 that denotes a packet data part, a 20-byte long Transport Control Protocol (TCP) header 72 that forms the header part, a 20-byte long IP header 73, a 4-byte long PPP header 74, a 6-byte long PPPOE header 74, a 14-byte long Ethernet (registered trademark) header 76, and a 4-byte long frame check sequence 77 added at the end of the packet.

Both source and destination devices of each packet are identified by the source IP address 734 and the destination IP address 735 included in the IP header 73. The application programs used in the source and destination devices are identified by the source port number 721 and the destination port number 722 included in the TCP header 72. The PPPOE header 75 includes a session ID 753 used as identification information of each of the PPP sessions 611 to 621. Transferring of packets between nodes of an access network are controlled according to a destination MAC address 761 and a source MAC address 762 set in the Ethernet header 76.

In the access node apparatus 10-1 (10-2) of the present invention, the processor 130 of the input/output line interface connected to the access network 61 reads received packets of the format shown in FIG. 4 from the input buffer on the line side 112 and analyzes the contents in the headers 72 to 76.

The filtering table 134 includes preset type of processing to be executed for received packets in accordance with specific identification information such as the destination IP address, the source IP address, the destination port number, and the source port number. The present invention specifies data in the filtering table 134 so that the processor 130 collects access information in correspondence with the IP address of a specific server in which the user access condition is to be analyzed.

The processor 130 refers to the filtering table 134 according to the destination IP address included in the IP header 73 of each received packet to decide the type of a processing to be executed for the received packet.

When discarding of the received packet is specified as the type of the processing corresponding to the destination IP address of the received packet, the processor 130 discards the received packet. When transfer to the authentication server is specified as the above processing type, the processor 130 rewrites the Ethernet header 76 of the received packet from that of the access server 10-1 to that of the authentication server 20-1, then sends the received packet to the LAN 40 via the control processor interface 140. When the data link layer protocol of the LAN 40 is the Ethernet one, the Ethernet header 76 is replaced with that of another protocol.

When no special processing corresponding to the destination IP address of the received packet is specified in the filtering table 134, the processor 130 refers to the routing table 133 according to the destination IP address.

The routing table 133 stores an output port number to which the received packet is to be transferred in the access node and information required to convert the packet header in correspondence with the destination IP address.

The processor 130 thus reads the output port number corresponding to the destination IP address of the received packet from the routing table 133 to generate an internal header that includes this output port number for the received packet. In addition, the processor 130 removes unnecessary information from the received packet and adds the internal header to the packet, which is then sent to the output buffer on the switch side 113 as an internal packet.

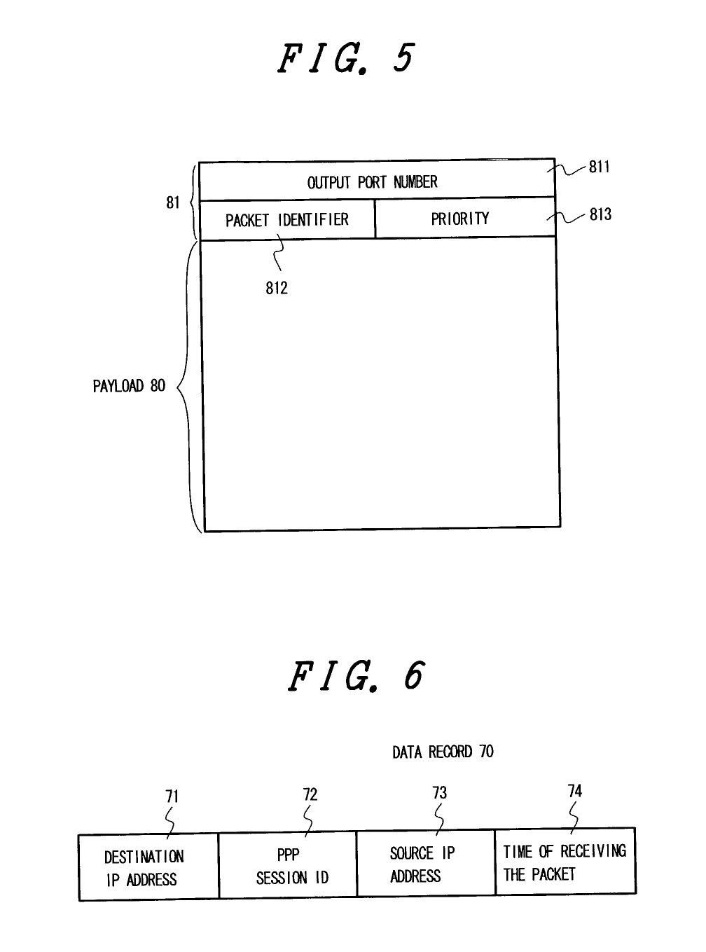

As shown in FIG. 5, the internal packet is configured of a packet body 80 and an internal header 81. The packet body 80 includes an IP packet part obtained by removing the Ethernet header 76, the PPPoE header 75, the PPP header 74, and the frame check sequence 77 from the received packet. The internal header 81 includes an output port number 811, a packet type 812, information that denotes a priority level of packet transfer in the switch 15. The priority level 813 is decided according to the type of the service (TOS) included in the IP header.

When collection of access information is specified as the processing type corresponding to the destination IP address of the received packet, the processor 130, for example, generates a data record shown in FIG. 6 and stores this record in the data record buffer 132, then converts the received packet to an internal packet.

In the fields 71 to 73 of the data record 70 are set values of the destination IP address 735, the source IP address 734, and the PPoE header session ID 753 extracted from the received packet. In the field 74 is set a packet receiving time. If the PPPoE header session ID can be identified from the value of the source IP address, either of them can be omitted from the data record 70.

The packet receiving time is obtained, for example, by referring to the current time timer when an access information record 70 is generated. If the Network Time Protocol Version 3 (NTP3) is mounted in each input/output interface, the current time can also be known from the NTP3. The NTP3 is regulated by the RFC 1305 of the Internet Engineering Task Force (IETF).

The internal packet stored in the output buffer on the switch side 113 is inputted to the switch 15 in the order set by the priority level 813 and output to an output line interface shown in FIG. 2 from the switch output port specified by the output port number 811 so as to be inputted to the input buffer on the switch side 121 shown in FIG. 3. In the input/output line interface connected to the access network, the input buffer on the switch side 121 receives packets from the ISP network 63. In the input/output line interface connected to the ISP network 63, the input buffer on the switch side 121 receives packets from the access network 61.

Reading the internal packet from the input buffer on the switch side 121, the processor 130 removes the unnecessary internal header 81 from the packet and refers to the routing table 133 according to the destination IP address of the packet. When the destination IP address 735 is the IP address of a user terminal, the header information required by the access network 61 is stored in the routing table 133. In this connection, the processor 130 converts the IP packet from which the internal header 81 is removed to a transmit packet of the format shown in FIG. 4 and transfers the transmit packet to the output buffer on the line side 122.

Note here that all the header information required for converting received packets to internal packets and internal packets to transmit packets are obtained from the routing table 133 so as to simplify the drawings. However, in order to use the table capacity effectively, it is also possible to store only the information required to process received packets in the routing table 133 and store information required to process transmit packets in another header information table.

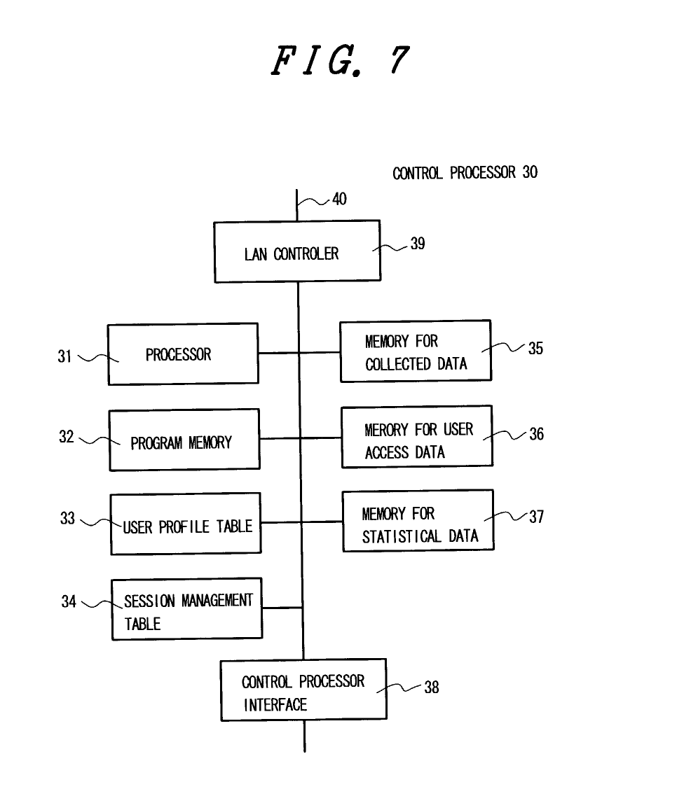

FIG. 7 shows an embodiment of the control processor 30 employed in the access node apparatus 10-1. The control processor 30 is configured by a processor 31, a program memory 32 for storing various programs executed by the processor 31, a user profile table memory 33, a session management table memory 34, a collected data memory 35, a user access data memory 36, a statistical data memory 37, a control processor interface 38 used to communicate with each input/output line interfaces 11-i (i=1 to n) and a LAN control processor 39 used to connect the access node apparatus 10-1 to the LAN 40. Those components are connected to each another via an internal bus.

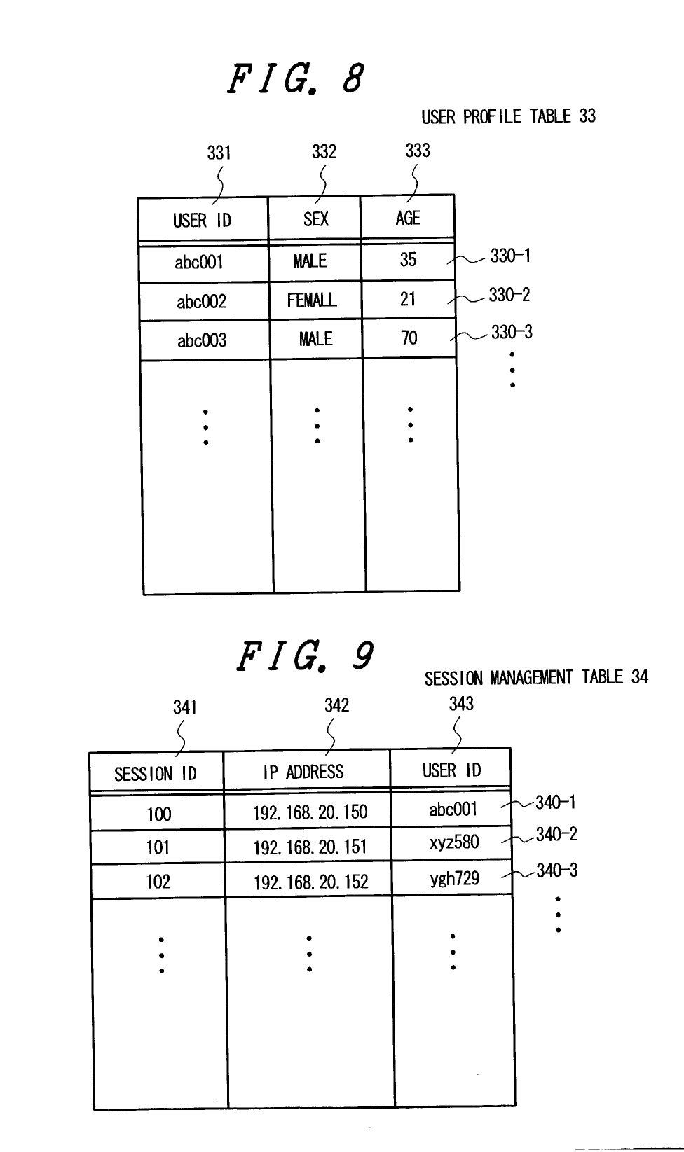

The user profile table 33 stores profile information of each user registered in the authentication server 20. The user profile table 33 includes, for example, a plurality of registered entries 330-1, 330-2, . . . each denoting such profile information as sex 332, age 333, etc. required to analyze the user's network using condition in correspondence with the user ID 331 as shown in FIG. 8. Those information items are set from the control terminal 21. New entries are added to the user profile table 33 when a new user is added to the ISP. The session management table 34 denotes correspondence between an IP address or PPP session set on the access network 61(62) and each user ID. In this case, for example, a plurality of entries 340-1, 340-2, . . . , each denoting the TP address 342 and the user ID 343 assigned to each user terminal, are registered in correspondence with each PPPoE session ID 341 as shown in FIG. 9.

The session management table 34, when a new PPP session is established between a user terminal and the access node apparatus 10-1, is to have newly added entries for the PPP session. When the PPP session is disconnected, the corresponding entries are deleted from the session management table 34.

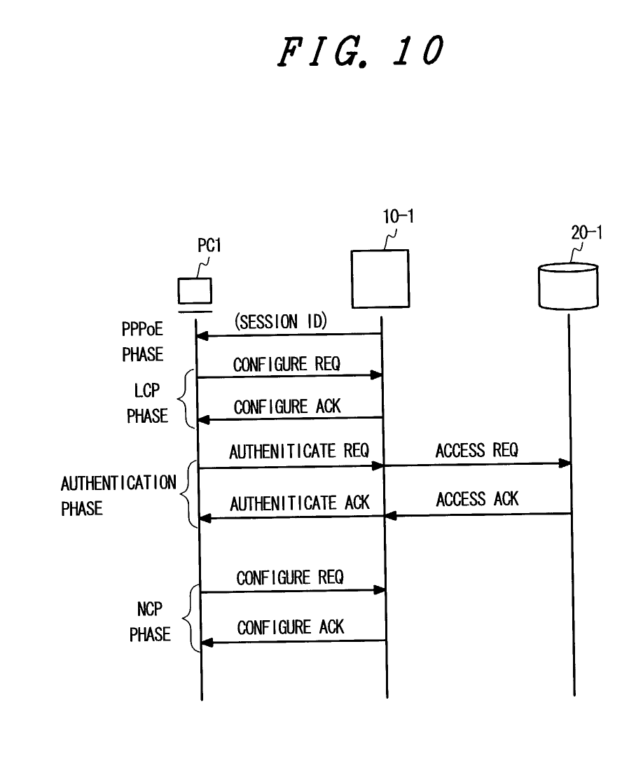

FIG. 10 shows procedures for controlling the communication to establish a PPP session between the user terminal PC1 and the access node apparatus 10-1, executed prior to the connection to the ISP network.

At first, a control procedure is executed so as to establish a data link between the terminal PC1 and the access node apparatus 10-1 in the Link Control Protocol (LCP) phase.

After the completion of the LCP phase, a control procedure of the authentication phase is executed according to such a protocol as the Password Authentication Protocol (PAP), the Challenge Handshake Authentication Protocol (CHAP) or the like that has successfully reduced such risks as password burglary. In the authentication phase, the user terminal sends his/her ID and password, which are then collated with those registered beforehand in the authentication server 20-1 so as to check the user validity.

After the confirmation of the user validity in the authentication phase, a Network Control Protocol (NCP) phase control procedure is executed between the terminal and the access node apparatus 10-1, so that such parameters as the IP address, etc. to be used in the user terminal required for the communication in the IP layer are decided.

When the PPPoE protocol is used for the communication between the user terminal PC1 and the access node apparatus 10-1, the PPPoE phase control procedure is executed prior to the above LCP phase, so that the PPP session ID is assigned to the user terminal from the access node apparatus. In each of the LCP, authentication, and NCP phases, packets with a PPPoE header that includes the above session ID added, respectively are used for the communication between the user terminal and the access node apparatus.

When a received packet read from the input buffer on the line side 112 is a control packet sent from a user terminal in any of the LCP, authentication, and NCP phases, the input/output interface processor 130 transfers the packet to the control processor 30 via the control processor interface 140. On the contrary, a control packet sent from the access node (control processor 30) to a user terminal is received by the control packet input buffer 135, then sent to the access network 61 via the output buffer on the line side 122 and the physical layer transmitter 123.

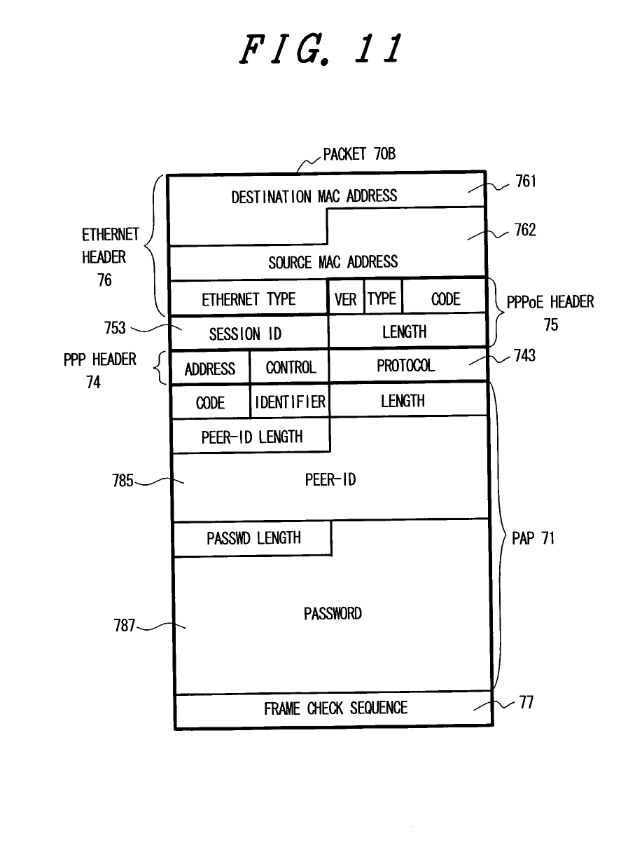

FIG. 11 shows a format of control packets (PAP packets) sent in the authentication phase when the PAP is used as an authentication protocol.

The PAP packet 70B is configured by a PPP header 74, a PPPoE header 75, and an Ethernet header 76 that are all set ahead of a payload part 71 and a frame check sequence 77 that is set after the payload part 71. If the set value of the protocol field 743 in the PPP header 74 is a hexadecimal number “C023”, the payload 71 that includes the PAP information comes after the PPP header and the fields 785 787 of the payload 71 include a user ID and a password, respectively.

The control processor 30, when receiving a packet from an input/output interface, can check the set value of the protocol field 743 in the PPP header added to the received packet to decide whether or not the received packet is a PAP packet 70B. When receiving the PAP packet 70B, the control processor 30 can refer to the fields 753 and 785 to recognize a relationship between the PPP session ID and the user ID.

The control processor 30 itself assigns an IP address to each authenticated user terminal. Consequently, the control processor 30 can recognize the correspondence among the PPP session ID, the user ID, and the user terminal IP address to add a new entry to the session management table 34 shown in FIG. 9.

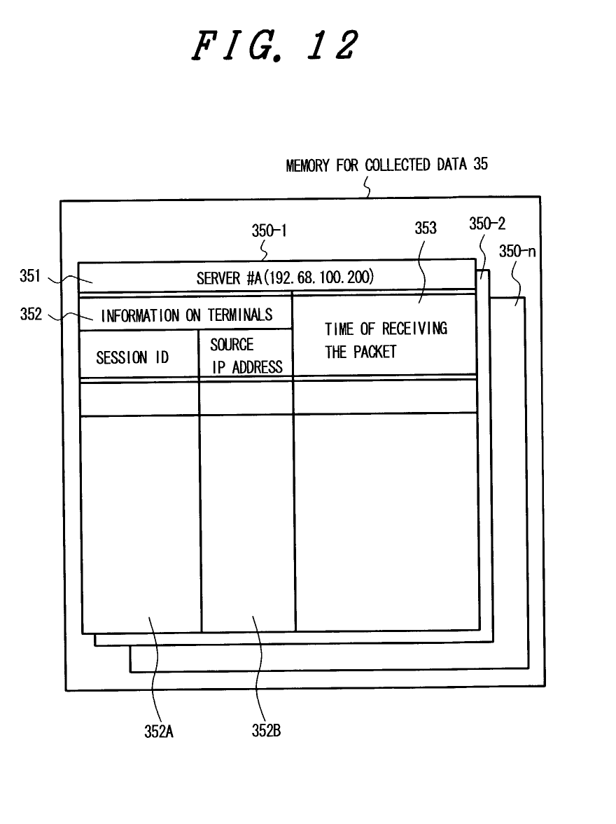

In the collected data memory 35 are formed a plurality of collected data tables 350-1 to 350-n corresponding to the servers (SW1, WS2, SW3, . . . shown in FIG. 1) accessed by user terminals as shown in FIG. 12. Server identification information (an IP address) 351 is assigned to each of those data tables. Each of the data tables stores a plurality of entries each denoting terminal information 352 and a packet receiving time 353. The terminal information 352 includes a session ID 252A and a source IP address 352B.

The control processor 30 requests sending of user access information periodically to each input/output interface connected to the access network to collect data records 70 (FIG. 7) stored in the data record buffer 132. The control processor 30 generates entries that include the PPPoE session ID 72, the source IP address 73, and the receiving time 74 extracted from each collected data record 70 and stores the entries in the data table 350-k shown in FIG. 12 corresponding to the destination IP address 71 (server address).

Completing storing of the entries in the collected data tables 350-i (i=1 to n), the control processor 30 reads entries sequentially from those tables and refers to the session management table 34 shown in FIG. 9 according to the terminal information 352 (session ID 352A and source address 352B) used as a key to find the user ID 343 corresponding to the above terminal information 352. Consequently, the packet receiving time 353 denoted by each entry in each collected data table can be corresponded to the user ID 343.

In the user access data memory 36 to which a server identification information (an IP address) 361 is assigned are formed a plurality of access data tables 360-1 to 360-n. Each data table stores a plurality of entries to denote a user ID 362 and a packet passing time 363.

Each of the access data tables 360-1 to 360-n stores entries, each denoting the correspondence between a user ID (362) and a packet receiving time (363) converted from each data entry stored in each of the collected data tables 350-1 to 350-n. Each access data table thus identifies a time at which a user has accessed a server. Completing conversion to those access data tables 360-1 to 360-n, the control processor 30 erases data from the collected data tables 350-1 to 350-n, since the data stored in them is not used any longer, thereby preparing for the next collection of data.

Hereinafter, a description will be made for statistical data processings executed by the control processor 30.

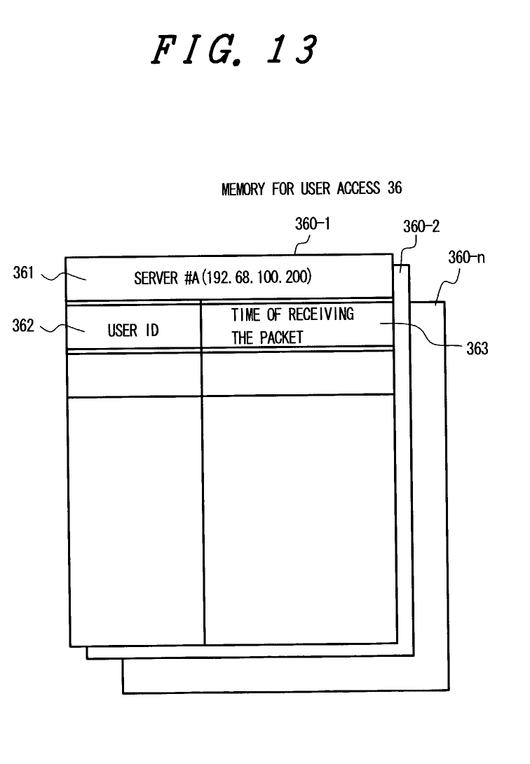

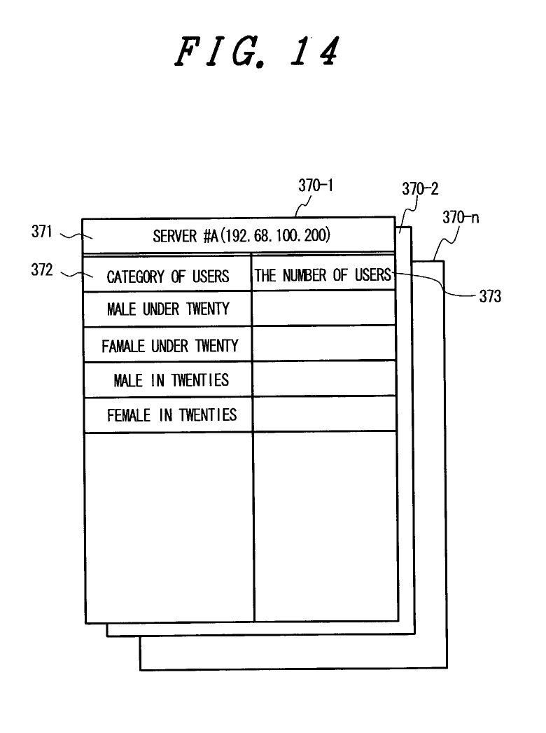

FIG. 14 shows statistical data tables 370-1 to 370-n used to denote a user profile distribution of each server, created on the basis of the access data tables 360-1 to 360-n shown in FIG. 13 and the user profile information table 33 shown in FIG. 8.

Each statistical data table 370-i (i=1 to n) denotes a distribution of users 373 classified by age/sex denoted by the user category 372 with respect to the users who have accessed a server identified by the IP address 371.

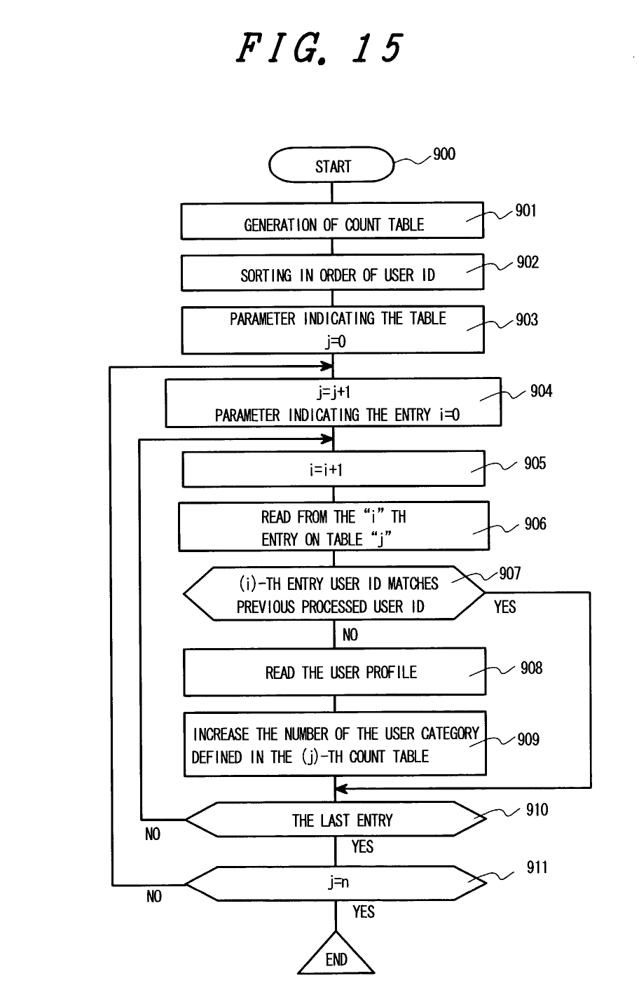

FIG. 15 shows a flowchart of a statistical processing routine 900 executed by the control processor to create the above described statistical data table.

At first, the routine 900 prepares a count table in the statistical data memory 37 (step 901). The table is used to count a statistical value of each server. This count table is equivalent to the statistical data table 370-i (i=1 to n) in which the number of users 373 in each field is zero.

Next, the registered entries in the access data tables 360-1 to 360-n shown in FIG. 13 are sorted in the order of user IDs (step 902) and the values of the table specification parameters j are initialized (step 903). After this, the value of each parameter j is increased by one and the value of the entry specification parameter i is initialized (step 904). Then, the value of the parameter i is increased (step 905) to read the (i)-th entry of the (j)-th user access data table 360-j (step 906).

Then, the (i)-th entry user ID 363 is compared with the previous processed user ID (step 907). When both IDs do not match, control goes to step 910 to decide whether or not the (i)-th entry is the last one in the user access data table 360-j. When it is not the last entry, control goes back to step 905. When it is the last entry, it is decided whether or not the parameter j matches with the last table number n (step 911). When they match, this routine is terminated. Otherwise, control goes back to step 904.

If the user ID 362 does not match with the processed user ID in step 907, the control processor 30 reads the user profile corresponding to the above user ID 362 from the user profile information table 33 (step 908) to find the user count field equivalent to the above user profile in the user category 372 defined in the (j)-th count table and increase the number of users (step 909). After this, the control processor 30 decides whether or not the (i)-th entry is the last one in the user access data table 360-j (step 910). If it is not the last entry, control goes back to step 905 to repeat the above processings.

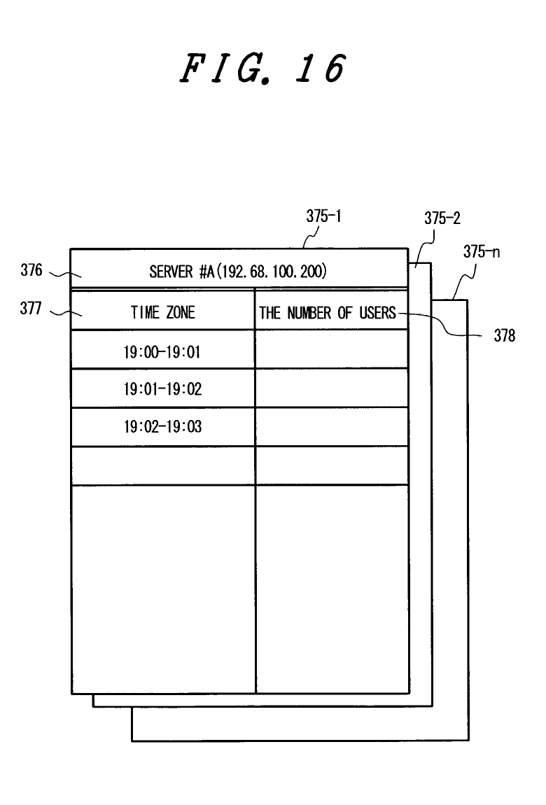

FIG. 16 shows statistical data tables 375-1 to 375-n created only with use of the access data tables 360-1 to 360-n as the second example of the statistical data output of the present invention. Each of the statistical data tables 375-i (i=1 to n) denotes a distribution of users 378 classified by the time band 377 in which a server identified by the IP address 371 is accessed.

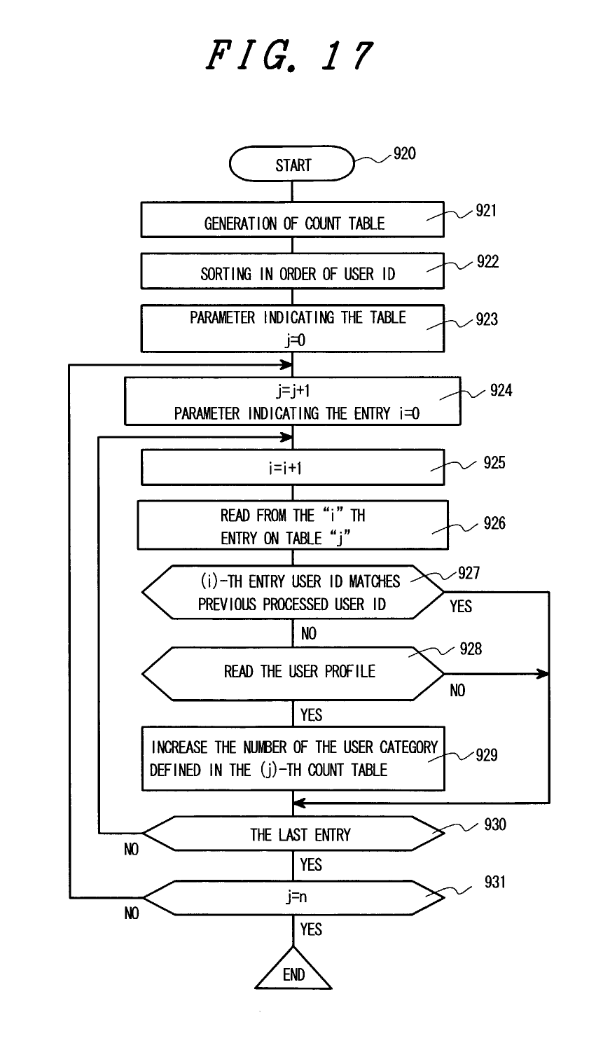

FIG. 17 shows a flowchart of the statistical processings executed by the control processor 30 to create the above described statistical data tables 375-1 to 375-n.

At first, the statistical processing routine prepares a count table in the statistical data memory 37 (step 921). The count table is used to count the statistical value of each server. This count table is equivalent to the statistical data table 375-i (i=1 to n) shown in FIG. 16 when the number of users 378 in each field is zero.

Next, the control processor 30 sorts the entries registered in the access data tables 360-1 to 360-n in the order of user IDs (step 922), then initializes and increases the values of the parameters j and i (steps 923 to 925) similarly to the steps 902 to 905 in the flowchart shown in FIG. 15. After that, the control processor 30 reads the (i)-th entry from the (j)-th user access data table 360-j (step 926).

The control processor 30 then compares the (i)-th entry user ID 362 with the previous processed user ID (step 927). When both user IDs match, the control processor makes decisions (steps 930 and 931) similarly to the steps 910 and 911 in FIG. 15. When the user IDs do not match, the control processor decides whether or not the packet receiving time 363 denoted by the (i)-th entry is included in any time band defined in the (j)-th count table (step 928). When the decision result is NO (not included), control goes to step 930. When the decision result is YES (included), the control processor increases the number of users in the user count field in the subject time band (step 929).

In the actual application, however, the control terminal 21 specifies a type of the statistical routine and a statistics collecting period, then instructs the control processor 30 to execute the specified statistical routine and output the result to itself 21. In this connection, the control processor 30, when reading the (i)-th entry from the access data table (steps 906 and 926), can compare the packet receiving time 353 denoted by the read entry with the specified statistics collecting period and remove the receiving time 353 if the time 353 is not within the specified period.

In the above embodiment, the control processor 30 of the access node apparatus 10-1 creates a user access data table 360-i (i=1 to n) that stores a relationship between an accessing user ID and an access time (packet receiving time) for each target server and refers to the user profile information table 33 as needed, thereby analyzing each server using condition according to the user profile. The above embodiment of the present invention can also be modified as follows, however. The control processor 21 fetches a user access data table 360-i (i=1 to n) into itself and uses the table to collect statistics of various data items. When the memory capacity of the control processor 30 is enough, user profile information in the user profile information table 33 can be added to the user access data table 360-i, so that only the user access data table 360-i is used to collect various statistical data according to the user profile.

The above embodiment of the present invention can also be modified as follows. The authentication server 20-1 is provided with a user profile information table beforehand and the authentication server 20-1 fetches a user access information table 360-i (i=1 to n) generated by the access node apparatus 10-1 into itself so as to calculate various types of statistical data on its side.

While the control processor 30 generates records to be registered in the session management table 34 in the above embodiment, the processor 130 of each input/output interface can also generate those records and transfer them to the control processor 30.

While the type of each processing to be executed by the processor 130 is defined according to the destination IP address of each received packet in the filtering table 134 in the above embodiment, it is also possible to define each processing to be executed by the processor 130 according to the PPPoE session ID in the filtering table 134 and execute a statistical processing for each packet received from a specific PPP session.

On the contrary, it is also possible to use the filtering table 134 for other than the statistical processing, for example, for discarding packets and make each input/output interface generate user access information data records 70 for all the packets received from a user terminal and instruct the control processor 30 to select a data record according to the destination address 71 of each data record so as to collect the statistics.

While a user access information table 360-i (i=1 to n) is generated on the basis of each packet received from a user terminal in the above embodiment, the user access information table 360-i (i=1 to n) can also be generated on the basis of each packet sent from any of the servers WS1 to WS3 to a user terminal. In this connection, the control processor 30 comes to store entries, each of which includes a PPP session ID, a destination address (user terminal IP address), and a packet receiving time extracted, respectively from the above data record in a data table 350-i corresponding to a source address (server IP address) 73 included in the data record 70 collected from the input/output interface connected to the ISP network 63.

The user profile information table 33 in the above embodiment just includes data of user profile, sex, and age. In the actual application, however, the statistical data output can be diversified apparently with other profiles such as the occupation, address, etc. of each user added to analyze the using condition of the subject server more effectively.

As to have been understood from the above embodiment, the access node apparatus of the present invention makes it possible to analyze the Internet using condition of each ISP subscriber according to his/her profile information. Consequently, according to the present invention, statistical data analyzed in correspondence with such the user profile can be obtained with respect to each information providing server on the Internet to be accessed via the above access node apparatus, so that ISP and Web service providers will be able to have profitable information.

What is claimed is:

1. An access node apparatus disposed between an access network connected to a plurality of user terminals and a network service provider (ISP) connected to the Internet and enabled to connect any of said plurality of user terminals to a user authentication server so as to authenticate its user prior to the connection to said ISP network, said apparatus comprising:
a user profile table for storing the profile information of each ISP network user corresponding to the identifier;
means for generating a management record denoting the correspondence between a user identifier and an IP address assigned to each of said user terminals in a process for executing a series of control procedures between said user terminal and said access node apparatus and between said user terminal and said authentication server prior to the connection of said user terminal to said ISP network;
means for generating a data record when receiving a packet sent to said server connected to the Internet from said user terminal, said data record denoting a relationship among a packet receiving time, a source IP address, and a destination IP address of said received packet;
means for generating a server access record denoting a relationship among said source IP address, said receiving time, and said user identifier of said received packet according to the contents of said data record and the contents of said management record, then storing said generated server access record in an access data table; and
means for generating statistical data analyzed in correspondence with user profile information for each server denoted by said source IP address with use of data stored in both of said access data table and said user profile table.

2. The access node apparatus according to claim 1;
wherein said management record includes a connection identification set for said access network as a packet communication one used between said user terminal and said access node apparatus; and
wherein said data record generated for said received packet includes a connection identifier set for said access network, said identifier being extracted from the header part of said received packet.

3. An access node apparatus disclosed between an access network connected to a plurality of user terminals and a network service provider (ISP) connected to the Internet and enabled to connect any of said plurality of user terminals to a user authentication server so as to authenticate its user prior to the connection to said ISP network, said apparatus comprising:
a user profile table for storing the profile information of each ISP network user corresponding to the identifier;
means for generating a management record denoting the correspondence between a user identifier and an IP address assigned to each of said user terminals in a process for executing a series of control procedures between said user terminal and said access node apparatus and between said user terminal and said authentication server prior to the connection of said user terminal to said ISP network;
means for generating a data record when receiving a packet sent to said user terminal from a server connected to the Internet, said data record denoting a relationship among a packet receiving time, a source IP address, and a destination IP address of said received packet;
means for generating a server access record denoting a relationship among said source IP address, said receiving time, and said user identifier of said received packet according to the contents of said data record and the contents of said management record, then storing said generated server access record in an access data table; and
means for generating statistical data analyzed in correspondence with user profile information for each server denoted by said source IP address with use of the data stored in both of said access data table and said user profile table.

4. The access node apparatus according to claim 1;
wherein said apparatus is configured by a plurality of input/output line interfaces connected to said access network or ISP network, a switch for switching packets among said input/output line interfaces, and a control processor connected to said plurality of input/output line interfaces;
wherein one of said plurality of input/output line interfaces includes said data record generating means; and
wherein said control processor is provided with said user profile table and enabled to function as said management record generating means, said server access record generating means, and said statistical data generating means, respectively.

5. The access node apparatus according to claim 4;
wherein said apparatus further includes an external terminal connected to said control processor and enabled to function as said statistical data generating means.

6. The access node apparatus according to claim 4;
wherein one of said plurality of input/output line interfaces is provided with a memory for storing said data record; and
wherein said control processor collects data records from said plurality of input/output line interfaces at a predetermined timing to convert each of those data records to an access record used for accessing said server.

7. The access node apparatus according to claim 4;
wherein one of said plurality of input/output line interfaces, when receiving a communication packet to be transferred between a user terminal and a predetermined specific server, generates said data record.

8. The access node apparatus according to claim 3;
wherein said apparatus is configured by a plurality of input/output line interfaces connected to said access network or ISP network, a switch for switching packets among said input/output line interfaces, and a control processor connected to said plurality of input/output line interfaces;
wherein one of said plurality of input/output line interfaces includes said data record generating means; and
wherein said control processor is provided with said user profile table and enabled to function as said management record generating means, said server access record generating means, and said statistical data generating means, respectively.

9. The access node apparatus according to claim 8;
wherein said apparatus further includes an external terminal connected to said control processor and enabled to function as said statistical data generating means.

10. The access node apparatus according to claim 8;
wherein one of said plurality of input/output line interfaces is provided with a memory for storing said data record; and
wherein said control processor collects data records from said plurality of input/output line interfaces at a predetermined timing to convert each of those data records to an access record used for accessing said server.

11. The access node apparatus according to claim 8;
wherein one of said plurality of input/output line interfaces, when receiving a communication packet to be transferred between a user terminal and a predetermined specific server, generates said data record.

12. A method for analyzing an Internet using condition of each user terminal, said method being employed for an access node apparatus disclosed between an access network connected to a plurality of user terminals and a network service provider (ISP) connected to the Internet and enabled to connect any of said plurality of user terminals to a user authentication server so as to authenticate its user prior to the connection to said ISP network, said method comprising the steps of:
generating a management record denoting the correspondence between a user identifier and an IP address assigned to each of said user terminals in a process for executing a series of control procedures between said user terminal and said access node apparatus and between said user terminal and said authentication server prior to the connection of said user terminal to said ISP network;
generating a data record when receiving a packet sent from said user terminal to said server connected to the Internet, said data record denoting a relationship among a packet receiving time, a source IP address, and a destination IP address of said received packet;
generating a server access record denoting a relationship among said source IP address, said receiving time, and said user identifier of said received packet according to the contents of a user profile table for storing the profile information of each ISP network user corresponding to the prepared identifier and the contents of said data record, then storing said generated server access record in an access data table; and
generating statistical data analyzed in correspondence with user profile information for each server denoted by said source IP address with use of the data stored in both of said access data table and said user profile table.
